(19) United States
(12) Patent Application Publication
(10) Pub. No.: US 2025/0283324 A1
(43) Pub. Date: Sep. 11, 2025

(54) BUILDING TRUSS WIRE GUARD SYSTEM AND METHOD OF USE

(71) Applicant: Oxford Ridge LLC, Dayton, ID (US)

(72) Inventors: Ron REED, Dayton, ID (US); Jed PINGREE, Millville, UT (US)

(73) Assignee: Oxford Ridge LLC, Dayton, ID (US)

(21) Appl. No.: 19/089,399

(22) Filed: Mar. 25, 2025

Related U.S. Application Data
(62) Division of application No. 18/121,560, filed on Mar. 14, 2023.
Application No. 18/121,560 is a continuation-in-part of application No. 29/824,644, filed on Jan. 26, 2022, now Pat. No. D1058000.
(60) Provisional application No. 63/320,394, filed on Mar. 16, 2022.

(51) Int. Cl. E04B 1/92; H01B 17/24

(52) U.S. Cl. CPC E04B 1/92; H01B 17/24

(57) ABSTRACT

A building truss wire guard system and method of use to keep electrical wire away from a metal gusset plate or pinch point. The system includes a guard apparatus with an elongate support member with first and second ends and fastener means adjacent to the ends configured to attach the apparatus to a truss member. A plurality of such apparatuses may be used within a system. A method of use involves providing a guard apparatus, locating a metal gusset plate or pinch point, positioning the guard apparatus at a truss location adjacent to the metal gusset plate or pinch point, and attaching the guard apparatus at the truss location, typically beyond the outer periphery of the metal gusset plate or pinch point. Wire may be placed, run, or pulled over the guard apparatus.

### RELATED APPLICATIONS

This application is a divisional application of U.S. non-provisional application Ser. No. 18/121,560 (filed on Mar. 14, 2023) which is the non-provisional of U.S. provisional application No. 63/320,394 (filed on Mar. 16, 2022), and a continuation-in-part of pending U.S. design patent application Ser. No. 29/824,644 (filed on Jan. 26, 2022) and claims priority to the foregoing applications.

### BACKGROUND OF THE INVENTION

In residential and other construction, conventional building trusses are used extensively as support framework. Metal gusset plates placed at truss vertices and/or connections are common features of installed trusses, particularly for roof and/or floor trusses in buildings. These metal gusset plates are generally of thin metal with rivets forming spikes on one side, the spikes configured to be pressed into the trusses to hold truss components together at a vertex. A typical construction may have many such metal gusset plates.

In construction or in remodeling existing constructions, electrical wiring usually takes place after completion of the framing of the structure, including truss placement. Electrical wiring often runs and snakes in a labyrinth throughout a building. Commonly, such wiring projects may require an electrician to pull, thread, or place wires adjacent to, across, or even within, one or more of the many truss vertices and metal gusset plates. Conventional electrical wiring is generally thermoplastic-sheathed or non-metallic sheathed cable (e.g., NM cable and/or Romex). If placed in friction contact with the metal gusset plates, wiring and/or sheathing may become damaged, weakened, or otherwise exposed during initial installation and/or over the lifetime of the wiring after it has been installed. Damaged or exposed wire from this poses a safety hazard to the house and its occupants through fire or electrocution, not to mention less life-threatening issues like potential damage to electrical appliances or equipment. The risk increases exponentially with the sheer number of metal gusset plates and the amount of wiring that may be involved in a given project or building.

Given the devastating risks of fire, electrocution, and/or electrical appliance or equipment damage, system is needed to mitigate the specific risk. A suitable risk mitigating system would address and resolve the dangers associated with sheathed electrical wiring coming into friction contact with metal gusset plates typical to trusses.

### SUMMARY OF THE INVENTION

In accordance with the above, a new and innovative building truss wire guard system is provided. The problems from sheathed electrical wiring coming into friction contact with metal gusset plates in trusses is solved. Embodiments of the present invention a building truss wire guard apparatus that is configured to keep electrical wire away from a metal gusset plate and a method of using the same. The guard apparatus may include an elongate support member with first and second ends and first and second fastener means adjacent to the ends that are configured to attach the ends to a truss member. In a method using the apparatus, the guard apparatus is provided, a metal gusset plate is located, the guard apparatus is positioned on a truss location—typically beyond the outer periphery of the metal gusset plate, and the guard apparatus is attached to the truss location. Wire may then be placed over the guard apparatus with the risks typically associated with running wire next to metal gusset plates.

These and other aspects of the present invention will become more fully apparent from the following description and appended claims or may be learned by the practice of the invention as set forth hereinafter.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is a front view of a metal gusset plate in a truss environment.

FIG. 2 is a perspective view of a plurality of metal gusset plates in a truss environment for an exemplary residential construction.

FIG. 3 is a front view of a first embodiment of a building truss wire guard apparatus adjacent to a metal gusset plate in a truss environment.

FIG. 4 is a perspective view of an exposed sheathed wire adjacent to a metal gusset plate in a truss environment.

FIG. 5 is a perspective view of a first embodiment of a building truss wire guard apparatus protecting sheathed wire adjacent to a metal gusset plate in a truss environment.

FIG. 6 is an isometric view of a second embodiment of a building truss wire guard apparatus.

FIG. 7 is a first side view of a second embodiment of a building truss wire guard apparatus.

FIG. 8 is a second side view of a second embodiment of a building truss wire guard apparatus.

FIG. 9 is an end view of a second embodiment of a building truss wire guard apparatus.

FIG. 10 is a perspective view of a second embodiment of a building truss wire guard apparatus adjacent to a metal gusset plate in a truss environment.

FIG. 11 is a block diagram of a method of use for a building truss wire guard apparatus in one embodiment.

### DETAILED DESCRIPTION OF THE ILLUSTRATED EMBODIMENT

The present invention in its various embodiments, some of which are depicted in the figures herein, is a building truss wire guard apparatus and method of use.

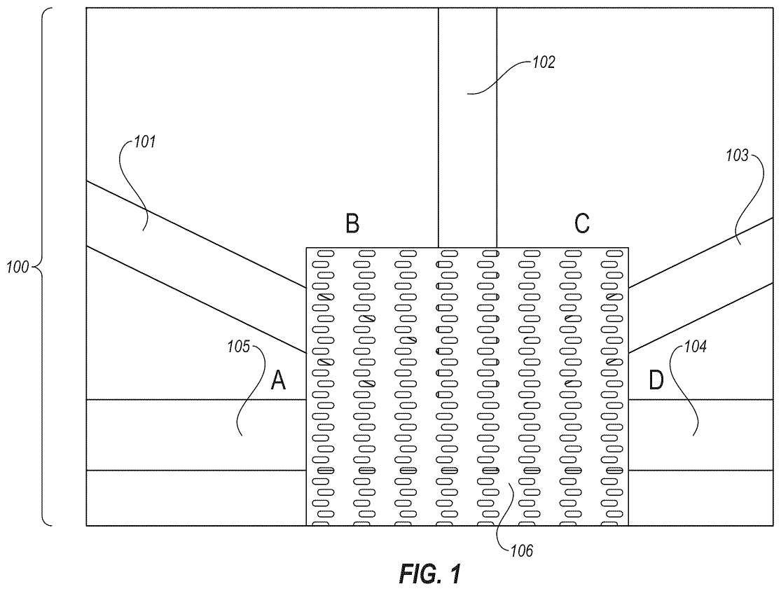

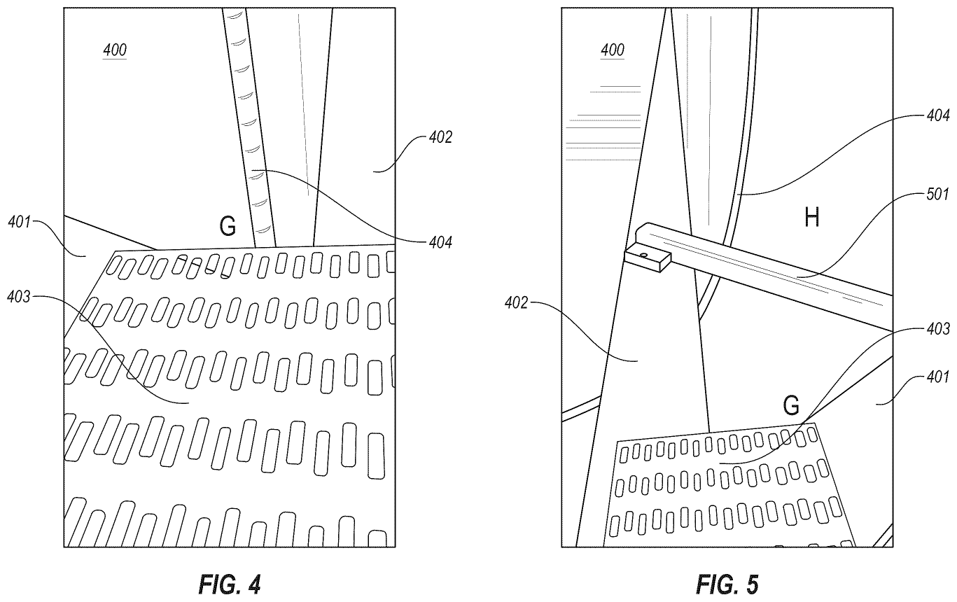

Referring now to FIG. 1, a truss environment 100 is shown, the truss having several support members, including 101-105 joined at a vertex. For clarity, truss environments may include floor trusses (e.g., FIGS. 1-3), ceiling trusses (e.g., FIG. 4, 5, or 10), or other truss locations and/or types. At the vertex, a metal gusset plate 106, helps join the truss members 101-105. In normal applications, the metal gusset plate 106 exceeds the boundaries of the vertex formed by the truss members. Accordingly, risk areas A, B, C, and/or D are created adjacent to the vertex. Commonly, electrical wiring and/or applications require that sheathed wiring be placed in or adjacent to, or moved across, such areas. Because areas A, B, C, and/or D expose such wiring to the sheer edges of the metal gusset plate 106, wiring may be damaged, weakened by friction, or even cut, thereby creating electrical hazards.

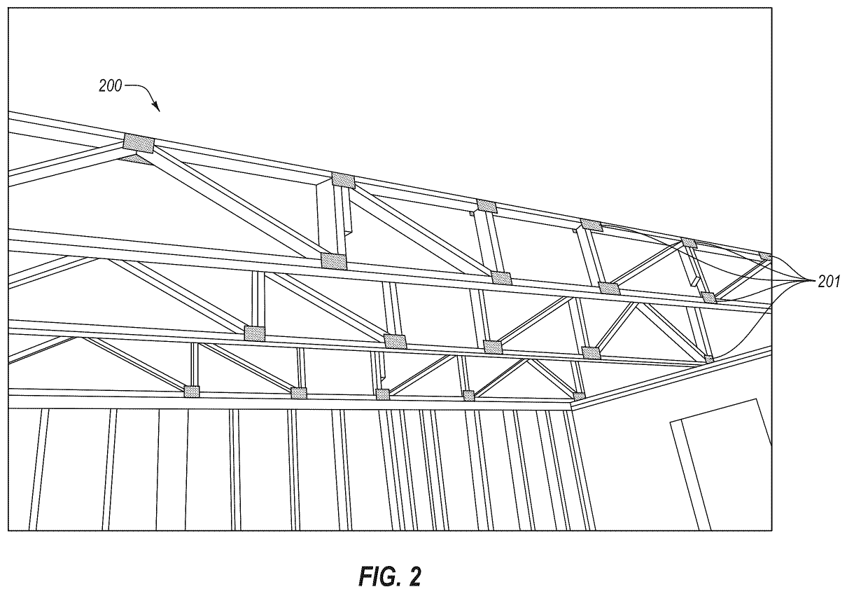

Referring now to FIG. 2, in an exemplary residential partial-construction 200, many such truss environments with risk areas and/or metal gusset plates—only a subset 201 of which are highlighted in FIG. 2—may be found. Therefore, the risk of electrical hazards created by these truss environments, metal gusset plates with their sheer edges, and subsequent application of sheathed wiring is amplified in common applications.

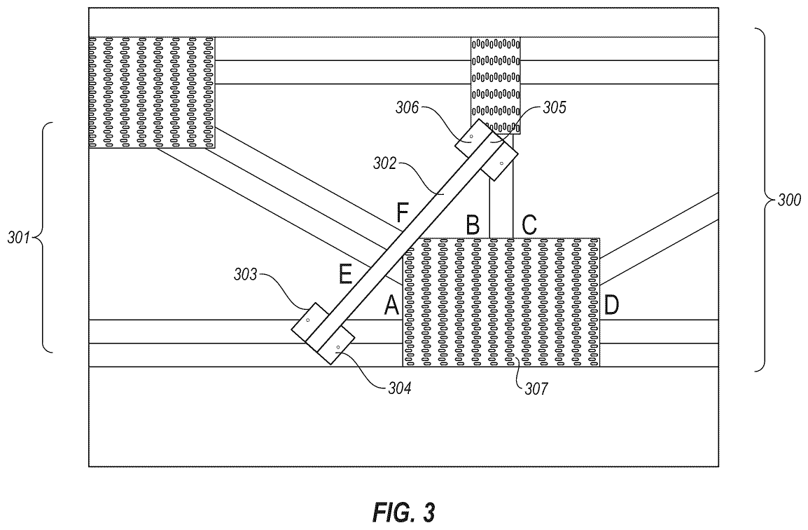

Referring now to FIG. 3, a first embodiment of a building truss wire guard apparatus 301 is shown in a first truss environment 300. As described in more detail below, building truss wire guard apparatus is configured to keep electrical wire away from a metal gusset plate. The wire guard apparatus 301 may be formed and/or made from any suitable non-conductive material, such as, for example a thermoplastic. Wire guard apparatus 301 may be formed of a single piece or of two or more pieces.

In general, wire guard 301 is comprised of an elongated support member 302 with a first end 303 having a first truss attachment means 304 and a second end 305 with a second truss attachment means 306. First 303 and/or second 305 ends may be oriented perpendicular to a longitudinal axis of the elongated support member 302, relatively wider than elongated support member 302 in a plane perpendicular to elongated support member 302, and/or have one or more generally planar surfaces configured to abut a truss support member. In some embodiments, generally planar surfaces are configured for placement proximal to the truss support member relative to the elongated support member 302. Truss attachment means may include, but are not limited to, apertures and/or channels for fasteners such as screws or nails. In certain embodiments, attachment means may be molded into the elongated support member. Regardless of the illustrated embodiment, many different types of attachment means or wire guard configurations may be used without departing from the purpose or scope of the invention.

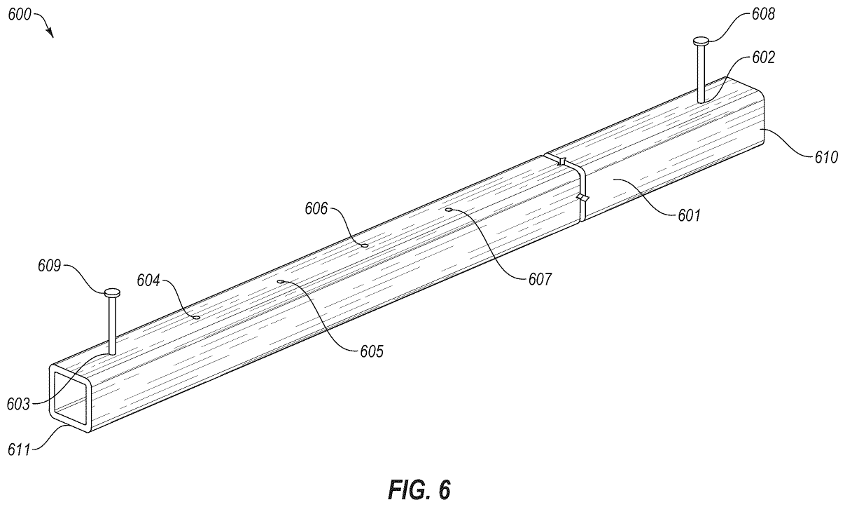

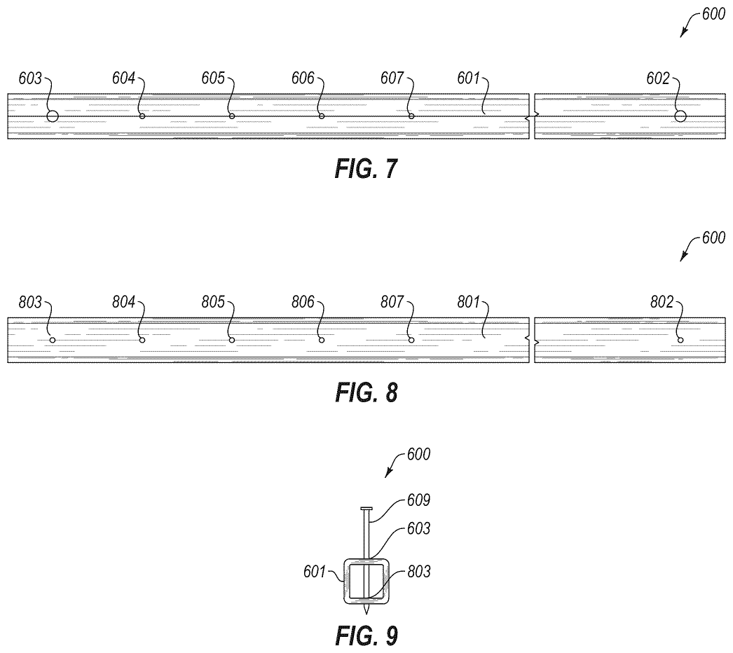

Referring now to FIGS. 6-9, a second embodiment of a building truss wire guard apparatus 600 is shown. As with the first embodiment, second embodiment of the wire guard apparatus 600 may be formed and/or made from any suitable non-conductive material, such as, for example a thermoplastic like polyvinyl chloride (PVC) and be formed of single or multiple pieces. In the illustrated embodiment, wire guard 600 has a generally square or rectangular hollow or tubular body 601 formed into an elongated support member with first 610 and second ends 611. Between first 610 and second 611 ends, wire guard apparatus 600 may have a plurality of apertures or channels 602, 603, 604, 605, 606, 607, 802, 803, 804, 805, 806, 807 comprised of aligned aperture or channel pairs on opposing sides of the rectangular hollow body 601. (See, e.g., FIG. 9, 603, 803). Apertures or channels may have one or more nails 608, 609 disposed within aperture or channel pairs that extend through the rectangular hollow body 601 and form first and second truss attachment means for attaching the wire guard 600 to a truss.

In this second embodiment, the distance between the first and second truss attachments is adjustable and may be selected by an installer in the field by choosing from among aperture and/or channel pairs. In some embodiments, body surfaces are configured for placement proximal to the truss support member relative to the elongated support member 600. Again, truss attachment means may include, but are not limited to, apertures and/or channels for fasteners such as screws or nails; attachment means may be molded into the elongated support member. Exemplary dimensions and configuration for the specific illustrated embodiment includes a tubular body of 1″×1″×16″×⅛″, with a nail placed 1″ from each end and a total of 6 aperture pairs. Regardless of the illustrated embodiment, many different types of attachment means or wire guard apparatus configurations may be used without departing from the purpose or scope of the invention.

Referring to FIGS. 3 through 5, in operation, wire guard 301 is configured for placement to span a truss vertex, joint, or other area adjacent to one or more metal gusset plates so as to provide a barrier between placed electrical wiring and the one or more metal gusset plates 307, 403, thereby precluding contact between the two. Again, without the wire guard 301, wiring (not shown) placed adjacent to areas A and/or B would be subject to a high likelihood of damage, weakening, or cutting from the metal gusset plate 307, 403. This is shown especially in FIG. 4, where wiring 404 is damaged from being moved over the gusset plate 403. However, with placement of wire guard 301 adjacent to a truss vertex and/or joint so as to span risk areas A, B, and/or G, wiring (e.g., 404) may be rested and/or placed on or adjacent to a barrier surface provided by the wire guard 301 or 501, at an area distal to the metal gusset plate 307 so as to prevent contact between the wiring and the metal gusset plate 307.

Referring specifically now to FIGS. 4 and 5, a fourth truss environment 400 is shown. In FIG. 4, truss environment 400 includes a wire 404 adjacent to area G in contact with, near, and/or exposed to damage from, the metal gusset plate 403. In FIG. 5, first embodiment wire guard 501 is placed and fastened between truss members 401 and 402, adjacent to area G and the metal gusset plate 403 to provide a physical barrier between the wire 404 and metal gusset plate 403. With the wire guard 501 so placed, wire 404 may be rested and/or placed on or adjacent to the barrier surface provided by the wire guard 501, thereby avoiding risk of damage from the metal gusset plate 403. Significantly, wire guard 501 may be placed in any number of positions and/or configurations between truss members to accomplish the purposes and scope of the invention.

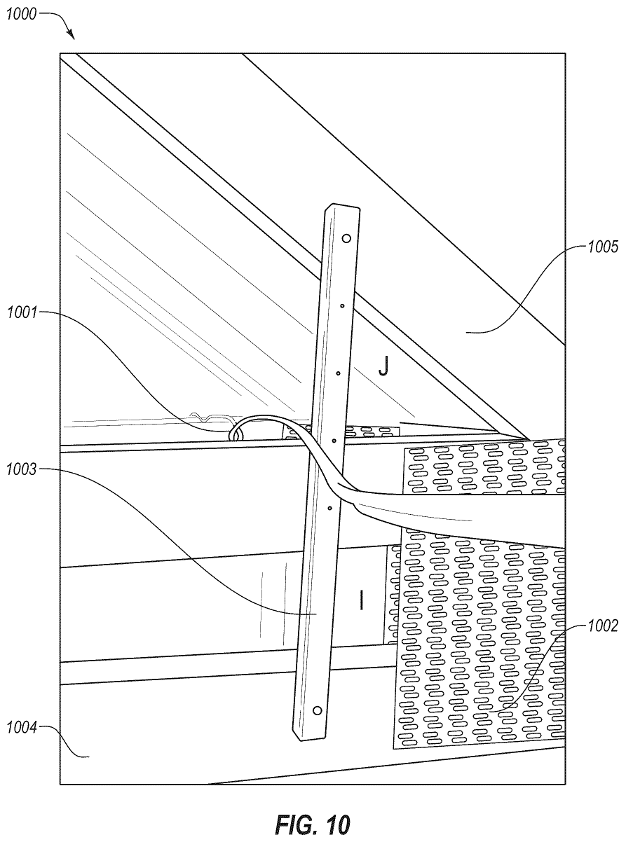

Referring now to FIG. 10, a fifth truss environment 1000 is shown. In FIG. 10, truss environment 1000 includes a wire 1001 adjacent to risk area I, that, without barrier, could place wire 1001 or another adjacent wire (not shown) in contact with, and/or exposed to damage from, the metal gusset plate 1002. In FIG. 10, second embodiment wire guard 1003 is placed and fastened between truss members 1104 and 1105, adjacent to area I and the metal gusset plate 1002 to provide a physical barrier between the wire 1001 and metal gusset plate 1002. With the wire guard 1003 so placed, wire 1001 may be rested and/or placed on or adjacent to the barrier surface provided by the wire guard 1003, thereby avoiding risk of damage from the metal gusset plate 1002. Significantly, wire guard 1003 may be placed in any number of positions and/or configurations between truss members to accomplish the purposes and scope of the invention.

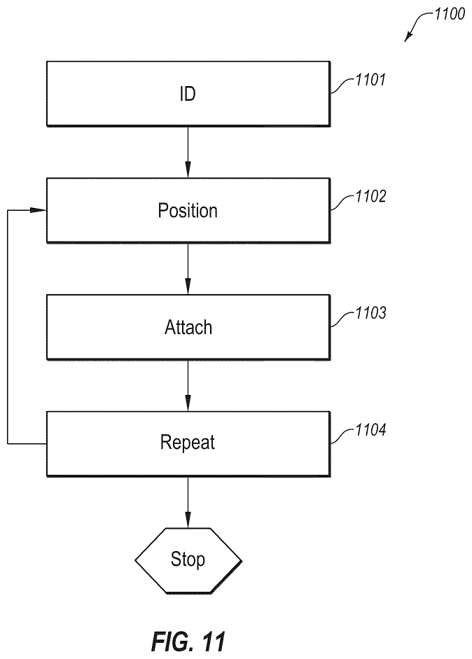

Referring now to FIG. 11, a method 1100 of using the wire guard is also disclosed. As a first step, a user identifies 1101 a metal gusset plant and/or a location where wiring will (or potentially will) contact a metal gusset plate. Typically, these locations are within truss environments (more particularly, adjacent to gussets) in new constructions or remodels. As a second step, one or more wire guards (from the above embodiments, or suitable equivalents) is positioned 1102 between truss members at a location distal to the metal gusset plate so as to prevent contact between the wiring and the metal gusset plate. In some embodiments, the distance between the metal gusset plate and the guard may be approximately four (4) inches in order to comply with applicable building codes and other regulations and best practices. In such positioning, fastening means such as nails are placed to face in the direction from which electrical wire will be pulled from to ensure that forces are directed towards the truss.

As a third step, the one or more wire guards is attached 1103 to truss members at wire guard first and second ends. In some embodiments, this involves placing a first end of the guard with a single hole on a first truss location at a desired distance from the gusset and hammering a first pre-placed nail until the first end is affixed, then pivoting the second end of the guard to a second truss location at a desired distance from the gusset and hammering a second pre-placed nail until the second end is affixed. As a fourth and final step, steps two and three are repeated 1104 as needed within other areas and/or truss environments. In various embodiments of the method, after these steps, wiring may “pulled” and/or installed over the wire guards without contacting the gussets.

So, configured the problems from sheathed electrical wiring coming into friction contact with metal gusset plates and/or pinch-points in trusses is solved. The guard and method can keep wire from coming in direct contact with gussets and shield the wire from being damaged during installation by providing a barrier whereby wire is pulled against the guard instead of being pulled against the metal gusset. Moreover, once the wire is installed, the guard can assist in maintaining the desired distance between the wire and gusset. As a further advantage, the guard makes electrical wiring easier to install by reducing pinch points and obstructions and by providing optimized surfaces for pulling electrical wiring through spaces.

The present invention may be embodied in other specific forms without departing from its spirit or essential characteristics. The described embodiments are to be considered in all respects only as illustrative and not restrictive. For example, the building truss wire guard system may include a plurality of building truss wire guard apparatuses in any number of shapes or configurations, with all kinds of fastening means suitable for addressing the problems addressed above. The scope of the invention is, therefore, indicated by the appended claims rather than by the foregoing description. All changes which come within the meaning and range of equivalency of the claims are to be embraced within their scope.

I claim:

1. A method for using a truss wire guard apparatus comprising the steps of:
providing a building truss wire guard apparatus configured to keep electrical wire away from one or more of a metal gusset plate and a pinch point, the building truss wire guard apparatus including an elongate support member having
a first end with a generally planar portion,
a second end, opposite the first end, with a generally planar portion,
a first fastener means adjacent the first end configured to attach the first end to a truss member, and
a second fastener means adjacent the second end configured to attach the second end to a truss member;
locating one or more of a metal gusset plate and a pinch point;
positioning the building truss wire guard apparatus on a truss location adjacent to the one or more of a metal gusset plate and a pinch point so that a portion of the building truss wire guard apparatus extends beyond an outer periphery of the one or more of a metal gusset plate and a pinch point; and
attaching the building truss wire guard apparatus to the truss location.

2. The method of claim 1, further comprising the step of running electrical wire over the portion of the building truss wire apparatus that extends beyond the outer periphery.

3. The method of claim 2, further comprising repeating the steps.

4. A method for using a truss wire guard apparatus consisting of the steps of:
providing a building truss wire guard apparatus configured to keep electrical wire away from one or more of a metal gusset plate and a pinch point, the building truss wire guard apparatus including
a single piece elongate support member having
a first end with a generally planar portion,
a second end, opposite the first end, with a generally planar portion,
a first channel adjacent the first end, the first channel generally perpendicular to a longitudinal axis of the single piece elongate support member, and
a second channel adjacent the second end, the second channel generally perpendicular to a longitudinal axis of the single piece elongate support member;
locating one or more of a metal gusset plate and a pinch point;
positioning the building truss wire guard apparatus on a truss location adjacent to the one or more of a metal gusset plate and a pinch point so that a portion of the building truss wire guard apparatus extends beyond an outer periphery of the one or more of a metal gusset plate and a pinch point; and
attaching the building truss wire guard apparatus to the truss location.

5. The method of claim 4, further consisting of the step of running electrical wire over the portion of the building truss wire apparatus that extends beyond the outer periphery.

6. The method of claim 5, further comprising repeating the steps.
